(19) United States
(12) Patent Application Publication
(10) Pub. No.: US 2016/0164329 A1
(43) Pub. Date: Jun. 9, 2016

(54) POWER CONTROL SYSTEM, POWER CONTROL METHOD AND RECORDING MEDIUM

(71) Applicant: NEC CORPORATION, Tokyo (JP)

(72) Inventors: Ryo HASHIMOTO, Tokyo (JP); Hitoshi YANO, Tokyo (JP); Hisato SAKUMA, Tokyo (JP); Koji KUDO, Tokyo (JP); Eisuke SANEYOSHI, Tokyo (JP); Takahiro TOIZUMI, Tokyo (JP)

(73) Assignee: NEC CORPORATION, Tokyo (JP)

(21) Appl. No.: 14/905,675

(22) PCT Filed: Jul. 2, 2014
(86) PCT No.: PCT/JP2014/067646

§ 371 Date: Jan. 15, 2016

(30) Foreign Application Priority Data
Jul. 19, 2013 (JP) 2013-150784

(51) Int. Cl. H02J 7/00; G05B 15/02; G05F 1/66

(52) U.S. Cl. CPC H02J 7/0068; G05F 1/66; G05B 15/02

(57) ABSTRACT

In order to solve the problem of a power grid becoming unstable due to a sharp increase in demand for electric power, the present invention provides a power control system to control the supply of electric power to a load or a storage battery in which the time period for supplying electric power is regulated. A power control system (101) of the present invention includes a receiving means (102) for acquiring power supply information including the amount of electric power to be supplied to other loads or storage batteries and a time period to supply electric power and, a determining means (105) for determining a time period to supply electric power to the load or storage battery based on the power supply information. Supplying electric power supply to the load or storage battery is performed in the time period determined by the determining means, so as to prevent timing congestion for supplying electric power.

### TECHNICAL FIELD

The present invention relates to a power control system, power control method and program for controlling power supply to a load or storage battery.

### BACKGROUND ART

Recently, under circumstances in which environment problems have become increasingly serious, renewable power sources such as solar batteries, wind-power generators and the like, which have rapidly proliferated and which have been introduced to the market, are regarded as effective means to achieve lower carbon emissions and to resolve the issue of energy resource.

However, the output power from renewable power sources of this kind greatly varies. Therefore, if a renewable power source having large output variation is connected to the power grid, a regulating means for balancing the output variation is a requisite in view of electric power quality.

Thermal power generators which are highly responsive have been mainly used under existing circumstances as the regulating means. Accordingly, the greater the introduction of renewable power sources which have large output variation, the greater is the need for thermal power generators that can regulate large output variation. As a result, it becomes very important to secure a regulating means that can replace thermal power generators.

The use of large-capacity storage batteries (e.g., NaS [sodium sulfur] batteries) for power grids is thought to be very effective, but installation and running costs represent significant barriers to the adoption of such storage batteries.

To resolve this dilemma, research has been undertaken on the use of devices of the consumer as the regulating means. Consumers, such as those who occupy ordinary houses, buildings and the like, pay electricity charges for the use of appliances based on the amount of power that is used. Under such circumstances, a study has been conducted concerning a “dynamic pricing demand response” (herein, a dynamic pricing demand response will be referred to as “DR”) which executes demand control by changing the consumer for electricity use based on the demand for electric power. At present, concerning DR, studies on estimation of the macro-level stabilizing effect on the entire power grid network and other researches have been continuously reported.

Meanwhile, automobiles that are powered by electricity are expected to spread rapidly as well as renewable power supplies. Hereinbelow, motors that are powered by electricity, inclusive of hybrid type electric motors that use a drive source other than electric power, are referred to as “EVs” (Electric Vehicles).

Furthermore, progress has been achieved in studies about V2G (Vehicle-to-Grid) technology which constructs a virtual high capacity storage battery that is made up of storage batteries that are used by a large number of EVs, controls the chargers for charging storage batteries in EVs to thereby use the virtual high capacity storage battery to stabilize the power grid. Proposals for VG2 technology started in 1980s, and studies on estimating the macro stabilizing effect across the entire power grid network have been continually reported. Further, in the past few years, small-scale control techniques for specific system construction, or technologies for controlling charging and discharging of a large number of EVs individually and in real-time, have been reported.

For example, Patent Document 1 discloses an EV charging scheduling device as well as an optimal charging scheduling device that uses a genetic algorism.

Patent Document 2 discloses a technology for performing stable EV charging without increasing the infrastructure capacity on the power grid network side, by using a stationary storage as a power buffer and having the stationary storage connected in series between the power grid network and EVs.

Though, in general, the term called “VG2” is used to refer to a system that is presumed to both charge EVs from the power grid and discharge electricity from EVs to the power grid (electric power system side), the system that is assumed to deal with charging EVs may only be called “G2V”. It is thought that the burden that is placed on the storage battery in an EV is reduced in G2V because the number of charging and discharging cycles is reduced.

### RELATED ART DOCUMENTS

### Patent Documents

Patent Document 1: JP2000-209707A
Patent Document 2: JP2010-213560A

### SUMMARY

### Problems to be Solved by the Invention

In order to stabilize the power grid by controlling charging of the storage batteries in EVs by use of the above technology, the charging system needs a charging manager that comprehensively manages the states of individual EVs (e.g., the charging state, connected state with the charger), the amount and time of charging performed by each EV charger to thereby directly control the chargers.

However, as to the charging system with a charging manager that directly controls individual chargers, it is difficult to early implement such a system in view of economical efficiency, protection of personal information (e.g., information on the state of the EV of each consumer) and stability of communication.

Under the circumstance in which there is no charging manager that directly controls charging of individual EVs, or under the circumstance in which there are many EVs that cannot be charged by the charging manager, charging of each EV is performed individually. In this case, it is anticipated that a large number of EVs can be arranged together to be charged at the same period.

If individual EVs are concentrated together to be charged at the same time, far from stabilizing the power grid, the charging of each EV will create instability in the power grid.

For purposes of consideration, one example would be a case in which the charging times of individual EVs are concentrated such that many owners of EVs begin to charge their vehicles at the same time which is a period I which the electricity price is low. If this situation happens, the risk is that there will be a sharp increase in the demand for electric power in the time period which the price of electricity is low, thus causing instability in the power grid. In the worst case, the frequency of electric power from power network lowers, possibly causing power failure.

In particular, when chargers automatically operate so as to charge EVs in a time period in which electricity price is low, it is thought that the problem, in which the charging times for charging EVs are concentrated, becomes a significant problem. For example, if an automatic DR charger, that has been developed for the sake of EV owner's convenience to operate in conformity with the policies, in which charging of a required amount of electricity will be completed at as low price as possible and as soon as possible until next use of the EV, become widespread, the chargers will begin charging simultaneously when the time period in which the price of electricity is low starts, expectedly causing a sharp load change.

FIG. 1 is a diagram showing a simulation result of change of load in three consecutive days, a holiday, a week day and subsequent week day, in a system including 1,000 EVs, as an example where the EVs cause a sharp load change in the DR of the related art. It was assumed herein that the basic price of electricity is 150 yen/kwh and the price is set at 50 yen/kwh from 10:00 to 12:00 and that the price of electricity is set at 0:00 every day. According to result of simulation under the above conditions, it could be confirmed that the demand for electricity temporarily increases at the time when the lower price of electricity starts.

The problem in which the power grid becomes unstable due to a sharp increase in demand for electric power, not only occurs when the devices to which electric power is supplied are EVs, but also occurs in devices other than EVs if supplying electric power is concentrated at the same time.

The object of the present invention to provide a power control system, power control method and program that can solve the above problem.

### Means for Solving the Problems

A power control system of the present invention is a power control system for controlling supply of electric power to a load or storage battery, including:

a receiving means for acquiring power supply information including the amount of electric power to be supplied to other loads or storage batteries and a time period to supply electric power; and,

a determining means for determining a time period to supply electric power to the load or storage battery based on the power supply information.

A power control method of the present invention is a power control method in which a power control system controls supply of electric power to a load or storage battery, comprising the steps of:

acquiring power supply information including the amount of electric power to be supplied to other loads or storage batteries and a time period to supply electric power; and,

determining a time period to supply electric power to the load or storage based on the power supply information.

A computer-readable recording medium is a computer-readable recording medium recorded with a program that causes a computer to execute control of supplying electric power to a load or storage battery, wherein

the program causes the computer to perform,

a receiving step of acquiring power supply information including the amount of electric power to be supplied to other loads or storage batteries and a time period to supply electric power; and,

a determining step of determining a time period to supply electric power to the load or storage based on the power supply information.

### Effect of the Invention

According to the present invention, it is possible to prevent power supply timing congestion for supplying power to loads or storage batteries.

### BRIEF DESCRIPTION OF THE DRAWINGS

FIG. 1 is a diagram showing a simulation result when a DR of the related art is used.

FIG. 2 is a diagram showing management system 10 including a power control system according to one exemplary embodiment of the present invention.

FIG. 3 is a diagram showing one example of charging control system 101.

FIG. 4 is a diagram showing one example of determined power amount signal Q(t).

FIG. 5 is a diagram showing one example of price signal P(t).

FIG. 6 is a diagram showing one example of a hardware configuration of charging control system 101.

FIG. 7 is a flow chart for illustrating the operation of charging control system 101.

FIG. 8 is a diagram showing one example of time t, priority time function φ(t) and supplying time period.

FIG. 9 is a diagram showing one example of determined power amount signal Q(t) after revision.

FIG. 10 is a diagram showing a simulation result when the present exemplary embodiment is applied.

FIG. 11 is a diagram showing a charging control system formed of information acquisition unit 102A and determination unit 105A.

### EXEMPLARY EMBODIMENT

Now, the exemplary embodiment of the present invention will be described with reference to the drawings.

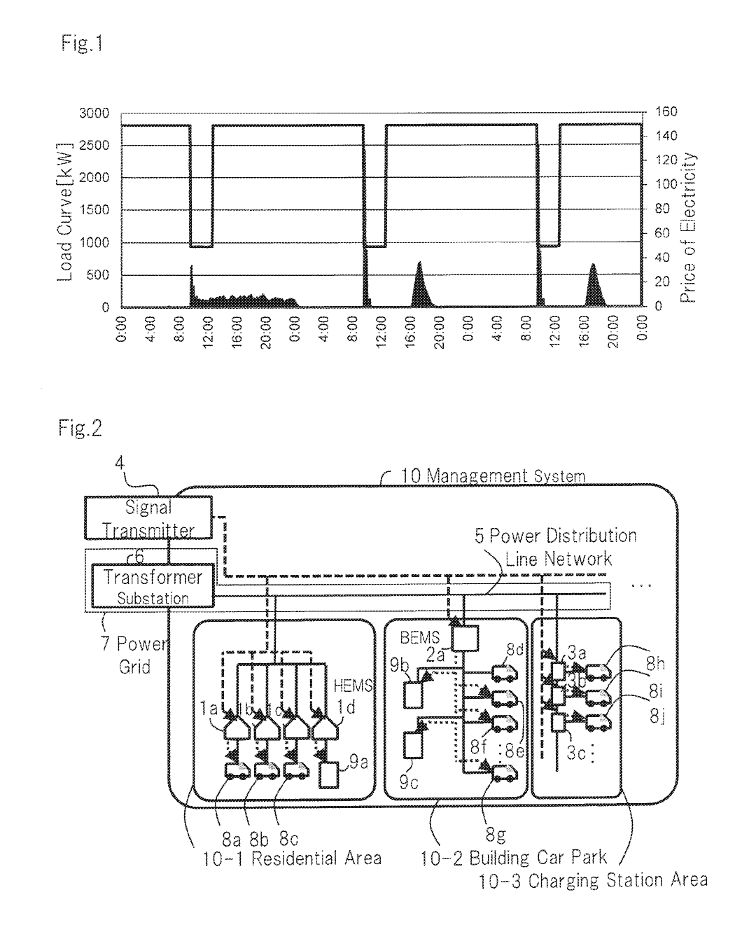

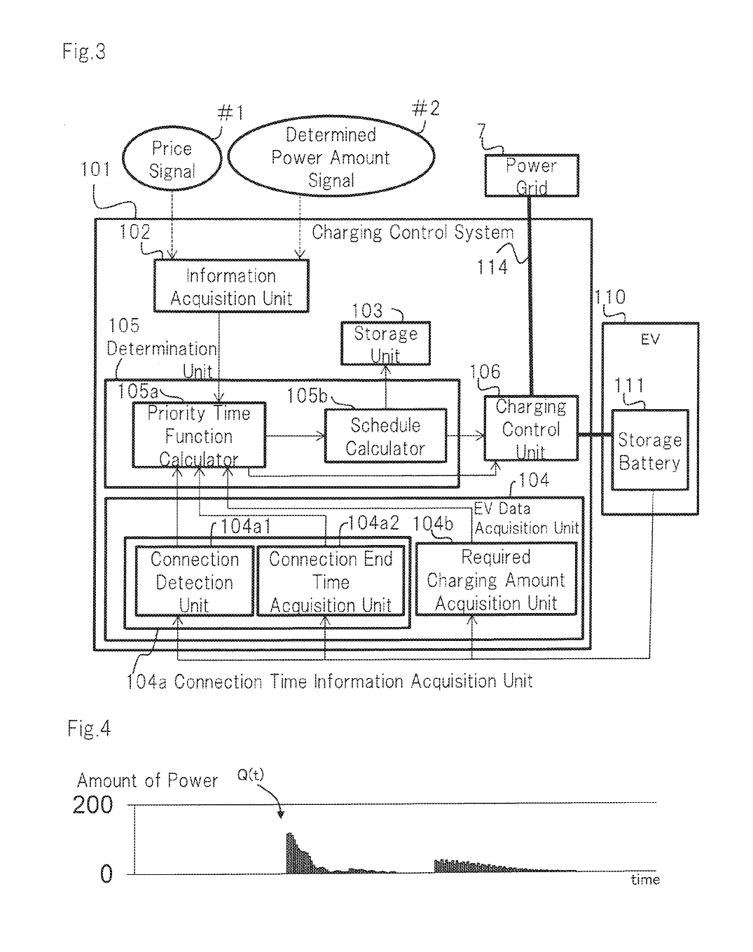

FIG. 2 is a diagram showing management system 10 including a power control system of one exemplary embodiment of the present invention.

In FIG. 2, management system 10 includes HEMS (Home Energy Management System) devices 1a to 1d installed in residential area 10-1, BEMS (Building Energy Management System) device 2a installed in building car park 10-2, charging stations 3a to 3c installed in charging station area 10-3 and signal transmitter 4.

HEMS devices 1a to 1d, BEMS device 2a and charging stations 3a to 3c are each connected to transformer substation 6 via power distribution line network 5. Here, power distribution line network 5 and transformer substation 6 are included in power grid 7. HEMS devices 1a to 1d, BEMS device 2a and charging stations 3a to 3c each communicate with signal transmitter 4.

HEMS devices 1a to 1c control charging and discharging of the storage batteries in EVs 8a to 8c, respectively. For example, HEMS devices 1a to 1c control supply of electric power from power grid 7 to EVs 8a to 8c, respectively. Here, EVs and storage batteries in EVs are examples of the predetermined power-supplied target or particular power-supplied target. Hereinbelow, “charging and discharging of the storage battery in EV will also be referred to as “EV charging and discharging”.

HEMS device 1d controls supply of electric power from power grid 7 to stationary energy storage (e.g., stationary storage battery or heat pump) 9a. Here, the stationary energy storage is an example of the predetermined power-supplied target or particular power-supplied target.

BEMS device 2a controls charging and discharging of EVs 8d to 8g and supply of electric power to stationary energy storage 9b to 9c. For example, BEMS device 2a controls supply of electric power from power grid 7 to EVs 8d to 8g and stationary energy storages 9b to 9c.

Charging stations 3a to 3c control supply of electric power from power grid 7 to EVs 8h to 8i, respectively.

Signal transmitter 4 transmits a price signal that indicates the electricity price depending on each point of time and a determined power amount signal that indicates the total amount of determined electric power to be supplied at each point of time, to HEMS devices 1a to 1d, BEMS device 2a and charging stations 3a to 3c.

The price signal is an example of price information and a function of time that indicates the electricity price at each point of time.

The price signal represents the electricity price at each point of time for one day, determined by the power supplier such as an electric power company or the like, and is transmitted from signal transmitter 4 on a day in advance of the date on which the electricity price that is indicated by price signal is valid. Here, the interval at which the electricity price that is indicated by the price signal is not one day, but may be changed as appropriate. The price signal may be transmitted at any timing as long as it is given in advance of the period of time for which the electricity price given by the price signal is valid.

The determined power amount signal is an example of power supply information, and is a function of time representing the total amount of determined electric power to be supplied to individual power-supplied targets at each point of time. Hereinbelow, “the total amount of determined electric power to be supplied to individual power-supplied targets at each point of time” may also be referred to simply as “determined electric power”.

Signal transmitter 4, in accordance with the revision of the determined electric power, updates the determined power amount signal and transmits the updated determined electric signal energy.

FIG. 3 is a diagram showing one example of charging control system 101 provided for each of HEMS devices 1a to 1d, BEMS device 2a and charging stations 3a to 3c. In FIG. 3, the same components as those shown in FIG. 2 are allotted with the same reference numerals. For description simplicity, the following description will be made by giving an example where charging control system 101 is equipped in HEMS device 1a. The charging control system of the present invention can be equipped in each of the HEMS devices, BEMS device, charging stations shown in FIG. 3, or may be installed as a system for managing these as micro grids. In this case, the charging control system is equipped, for example, in a control device connected to the HEMS devices, BEMS device, charging stations by way of a communication line.

In FIG. 3, charging control system 101 is an example of a power control system.

Charging control system 101 determines the charging schedule for storage battery 111 equipped in EV 110 and controls charging of storage battery 111 in accordance with the charging schedule. Here, EV 110 corresponds to EV 8a. Storage battery 111 is one example of a predetermined power-supplied target.

Here, the charging schedule for storage battery 111 indicates supplying time periods for supplying electric power from power grid 7 to storage battery 111 and electric power to be supplied from power grid 7 to storage battery 111 at each point of time in the supplying time period.

Charging control system 101 includes information acquisition unit 102, storage unit 103, EV data acquisition unit 104, determination unit 105 and charging control unit 106. EV data acquisition unit 104 includes connection time information acquisition unit 104a and required charging amount acquisition unit 104b. Connection time information acquisition unit 104a includes connection detection unit 104a1 and connection end time acquisition unit 104a2. Determination unit 105 includes priority time function calculator 105a and schedule calculator 105b.

Information acquisition unit 102 is one example of a power supply information receiving means.

Information acquisition unit 102 receives the price signal and the determined power amount signal from signal transmitter 4. For example, information acquisition unit 102 receives the price signal and the determined power amount signal by wired communication or wireless communication.

The determined power amount signal is prepared at signal transmitter 4, based on the charging schedules for the power-supplied targets (which will be referred to hereinbelow as “the other power-supplied targets”) such as other storage batteries, stationary energy storages and the like, which have been already determined in the other charging control systems, before charging control system 101 determines the charging schedule for storage battery 111. It should be noted that electric power is supplied from power grid 7 to the other power-supplied targets. The other power-supplied target is one example of a particular power-supplied target.

FIG. 4 is a diagram showing one example of determined power amount signal Q(t). In FIG. 4 the horizontal axis shows time while the vertical axis shows determined electric power.

FIG. 5 is a diagram showing one example of price signal P(t). In FIG. 5 the horizontal axis shows time while the vertical axis shows electricity price.

Every time information acquisition unit 102 shown in FIG. 3 receives determined power amount signal Q(t), the unit notifies the determined power amount signal Q(t) to priority time function calculator 105a. Every time information acquisition unit 102 receives price signal P(t), the unit notifies the price signal P(t) to priority time function calculator 105a.

Storage unit 103 is an example of a storing means.

Storage unit 103 stores a variety of information. For example, storage unit 103 stores weight information for determining weights for the determined amount of electric power indicated by determined power amount signal Q(t) and the electricity price indicated by price signal P(t).

In the present exemplary embodiment, storage unit 103 stores, as weight information, pairs of coefficient w1 showing the weight for the determined amount of electric power indicated by determined power amount signal Q(t) and coefficient w2 showing the weight for the electricity price indicated by price signal P(t).

Storage unit 103 further stores charging schedule for storage battery 111 determined by charging control system 101.

EV data acquisition unit 104 acquires information on storage battery 111.

Connection time information acquisition unit 104a is one example of a target information receiving means.

Connection time information acquisition unit 104a receives target information for specifying a permissible time period that permits supply of power to storage battery 111.

Connection detection unit 104a1 detects time at which storage battery 111 is connected to charging control system 101 (e.g., plug-in time of storage battery 111). Time at which storage battery 111 is connected to charging control system 101 will be referred to as “connection start time”.

For example, connection detection unit 104a1 has a clock unit (not shown). When receiving a connect signal indicating connection of storage battery 111 to charging control system 101, from an unillustrated connection detecting switch, the connection detection unit reads out time from the clock unit and uses the time as the connection start time.

Connection end time acquisition unit 104a2 acquires estimated time at which EV connection is ended (e.g., plug-out estimated time of storage battery 111). The estimated time at which EV connection is ended will be referred to hereinbelow as “scheduled connection end time”.

For example, connection end time acquisition unit 104a2 includes an input device such as a touch panel, or control buttons, and acquires the scheduled connection end time, which has been input through the input device by the user of EV 110.

It should be noted that the connection signal and the scheduled connection end time form the target information.

Required charging amount acquisition unit 104b is one example of a specifying means.

Required charging amount acquisition unit 104b specifies a required amount of energy to charge storage battery 111 (which will be referred to hereinbelow as “required charging amount”).

For example, required charging amount acquisition unit 104b detects the SOC (State of Charge) of storage battery 111 at the time of connection to EV, and calculates the required charging amount based on the difference between the above SOC and the target SOC to be the target level at charging completion. Here, the technique for calculating the required charging amount using SOC is publicly known, so that detailed description is omitted. The SOC of storage battery 111 at the time of connection to EV is one example of predetermined information.

Determination unit 105 is one example of a determining means.

Determination unit 105, based on determined power amount signal Q(t), price signal P(t), the weighting information (coefficient w1 and coefficient w2), the connection start time, the scheduled connection end time and the required charging amount, determines the charging schedule for storage battery 111.

Priority time function calculator 105a, based on determined power amount signal Q(t), price signal P(t) and weighting information (coefficient w1 and coefficient w2), generates a priority time function to be used to determine the charging schedule. The priority time function gives the level of recommendation for supplying power at each point of time. The level of recommendation for supplying power represents the degree to which supply of electricity to the power-supplied target at each time is recommended.

Priority time function calculator 105a sequentially receives determined power amount signals Q(t) and price signals P(t) from information acquisition unit 102.

Priority time function calculator 105a holds the latest determined power amount signal Q(t) of the sequentially received determined power amount signals Q(t). Priority time function calculator 105a also holds the latest price signal P(t) of the sequentially received price signals P(t).

Priority time function calculator 105a generates a priority time function based on the latest determined power amount signal Q(t), the latest price signal P(t) and the weighting information.

Schedule calculator 105b determines the charging schedule for storage battery 111, based on the priority time function, the connection start time, the scheduled connection end time and the required charging amount.

Charging control unit 106 is one example of a supplying means.

Charging control unit 106 supplies electric power from power grid 7 to storage battery 111, following the charging schedule calculated by schedule calculator 105b.

In the present exemplary embodiment, charging control unit 106 supplies electric power from power grid 7 to storage battery 111 at a predetermined level of power (for example, at the maximum value) within the rated power of storage battery 111. The predetermined level is not limited to the maximum value within the rated power of storage battery 111, but may be changed as appropriate within the range of the rated power of storage battery 111. Hereinbelow, the predetermined level is referred to as “the output power value”. In the present exemplary embodiment, the output power value is also set for priority time function calculator 105a.

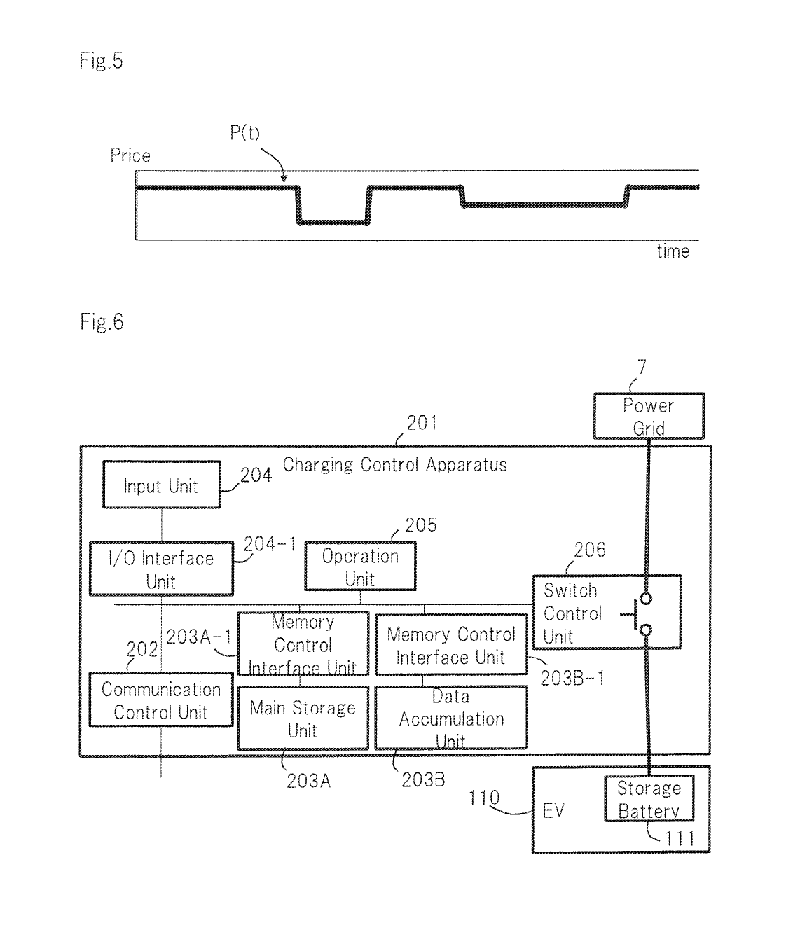

FIG. 6 is a diagram showing one example of a hardware configuration of charging control system 101. In FIG. 6, the same components as those shown in FIG. 3 are allotted with the same reference numerals.

Charging control apparatus 201 is one example of a control system, and has the same functionality as that of charging control system 101. Charging control apparatus 201 includes communication control unit 202, main storage unit 203A, data accumulation unit 203B, memory control interface units 203A-1 and 203B-1, input unit 204, I/O (Input/Output) interface unit 204-1, operation unit 205 and switch control unit 206.

Communication control unit 202 has the same functionality as that of information acquisition unit 102.

Main storage unit 203A is a storage unit mainly used by operation unit 205. When a computer such as a CPU (Central Processing Unit) or the like is used as operation unit 203A, main storage unit 203A stores programs for ruling the operation of operation unit 205. Memory control interface 203A-1 is the interface for main storage unit 203A.

Data accumulation unit 203B has the same functionality as that of storage unit 103. Memory control interface 203B-1 is an interface for data accumulation unit 203B.

Input unit 204 has the same functionality as that of EV data acquisition unit 104. I/O interface unit 204-1 is the interface for input unit 204.

Operation unit 205 has the same functionality as that of determination unit 105. Here, when a computer such as a CPU or the like is used as operation unit 205, operation unit 205 loads and runs the program stored in main storage unit 203A, to thereby realize the same function as that of determination unit 105.

Switch control unit 206 has the same functionality as that of charring control unit 106. For example, a relay switch is used for switch control unit 206. Here, switch control unit 206 is not limited to relay switches, but can be changed as appropriate.

Next, the operation will be described.

The description hereinbelow will be given on the assumption that the latest determined power amount Q(t) and the latest price signal P(t) are retained in priority time function calculator 105a.

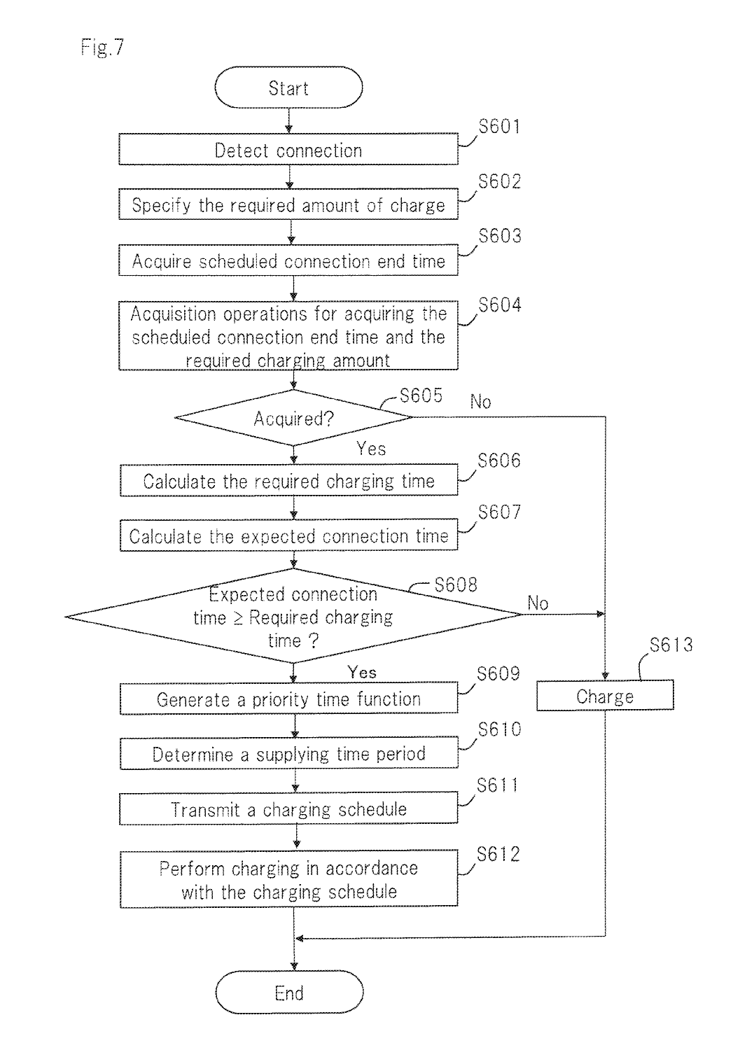

FIG. 7 is a flow chart for illustrating the operation of charging control system 101.

In order to charge EV 110 (storage battery 111), the user (e.g., the owner) of EV 110 connects EV 110 to charging control system 101 and enters the expected time to start to use EV 110 next time, or scheduled connection end time, by operating connection end time acquisition unit 104a2. Entry of the scheduled connection end time is done, for example, every time the user of EV 110 connects EV 110 to charging control system 101.

When EV 110 is connected to charging control system 101, connection detection unit 104a1 detects connection (EV connection) between charging control system 101 and EV 110 (Step S601) while required charging amount acquisition unit 104b specifies the required charging amount (Step S602). Connection end time acquisition unit 104a2 retains the entered scheduled connection end time (Step S603).

Connection detection unit 104a1, when detecting EV connection, specifies the connection start time, and notifies the connection start time to priority time function calculator 105a.

Priority time function calculator 105a, when receiving the connection start time, sends an acquisition request to connection end time acquisition unit 104a2 and required charging amount acquisition unit 104b to perform acquisition operations for acquiring the scheduled connection end time and the required charging amount (Step S604).

Connection end time acquisition unit 104a2, when receiving the acquisition request, notifies the scheduled connection end time to priority time function calculator 105a. Required charging amount acquisition unit 104b, when receiving the acquisition request, notifies the required charging amount to priority time function calculator 105a.

However, if a communication error takes place at connection end time acquisition unit 104a2 or required charging amount acquisition unit 104b, priority time function calculator 105a cannot obtain the schedule connection end time and/or the required charging amount.

To avoid this, priority time function calculator 105a determines whether the scheduled connection end time and the required charging amount have been obtained, after notification of the acquisition requests (Step S605). For example, at Step S605 priority time function calculator 105a determines whether the scheduled connection end time and the required charging amount have been obtained within a predetermined period of time after notification of the acquisition requests. Here, the predetermined period of time can be selected as appropriate.

Priority time function calculator 105a, when confirming acquisition of the scheduled connection end time and the required charging amount, divides the required charging amount by the output power value (electric power value to be supplied to storage battery 111) to calculate the required charging time (Step S606). Here, the required charging time is the shortest time needed for charging control unit 106 to charge the required charging amount to storage battery 111.

Then, priority time function calculator 105a subtracts the connection start time from the scheduled connection end time to calculate the expected connection time (Step S607). Here, the expected connection time is the expected time in which EV 110 is continuously connected to charging control system 101.

Next, priority time function calculator 105a determines whether the expected connection time is equal to or longer than the required charging time (Step S608).

If the expected connection time is equal to or longer than the required charging time, it is possible to complete charging of the required charging amount up to the scheduled connection end time, and priority time function calculator 105a generates a priority time function to be used for determining a charging schedule (Step S609).

Now, one example of Step S609 will be described.

Priority time function calculator 105a multiplies the latest determined power amount signal Q(t) by coefficient w1 and multiplies the latest price signal P(t) by coefficient w2, and adds up these products, to thereby define priority time function φ(t) by extracting the added result in the period between the connection start time to the scheduled connection end time.

Priority time function φ(t) can be represented as Eq. (1) below.

φ(t)=w1·Q(t)+w2·P(t) Eq. (1).

In Eq. (1), time t is defined in the range of the connection start time≦t≦the scheduled connection end time. The period of time from the connection start time to the scheduled connection end time (which will be referred to hereinbelow as “connection time period”) is one example of a permissible periods during which supply of electric power to storage battery 111 is permitted.

The value of priority time function φ(t) represents the recommended degree of power to be supplied: the smaller the value of priority time function φ(t), the higher is the recommended degree of power that is to be supplied.

Coefficient w1 assigns a weight to the latest determined power amount signal Q(t) and also functions as a conversion coefficient for converting the value (electric power) of the latest determined power amount signal Q(t) into the recommended degree of power to be supplied.

Coefficient w2 assigns a weight to the latest price signal P(t) and also functions as a conversion coefficient for converting the value (electricity price) of the latest price signal P(t) into the recommended degree of power to be supplied.

In the present exemplary embodiment, coefficient w1 is specified to be a positive value while coefficient w2 is specified to be a value equal to or greater than 0. For example, when w2 is 0, priority time function φ(t) is reduced to a function depending on the latest determined power amount signal Q(t), without depending on the latest price signal P(t).

The above is one example of Step S609.

Here, coefficients w1 and w2 can be set for each charging control system 101.

For example, an incentive such as discounting the electricity price, or giving points corresponding to a discount of the electricity price may be given to the EV user who, with coefficient w2 set at a value equal to or lower than the standard value (e.g., default value) of coefficient w2, sets coefficient w1 at a value greater than the standard value (e.g., default value) of coefficient w1.

Alternatively, an incentive such as discounting the electricity price, or giving points corresponding to a discount of the electricity price may also be given to the EV user who, with coefficient w1 set at a value equal to or greater than the standard value of coefficient w1, sets coefficient w2 at a value lower than the standard value of coefficient w2.

Subsequently, priority time function calculator 105a notifies priority time function φ(t), the required charging time, the connection start time and the scheduled connection end time to schedule calculator 105b.

Schedule calculator 105b, when receiving priority time function φ(t), the required charging time, the connection start time and the scheduled connection end time, determines the time period (which will be referred to hereinbelow as “supplying time period”) for supplying electric power from power grid 7 to storage battery 111, based on priority time function φ(t) (Step S610).

Here, since the electric power (output power value) supplied to storage battery 111 is determined previously, determining the supplying time period means determining the charging schedule for storage battery 111.

Now, one example of Step S610 will be described.

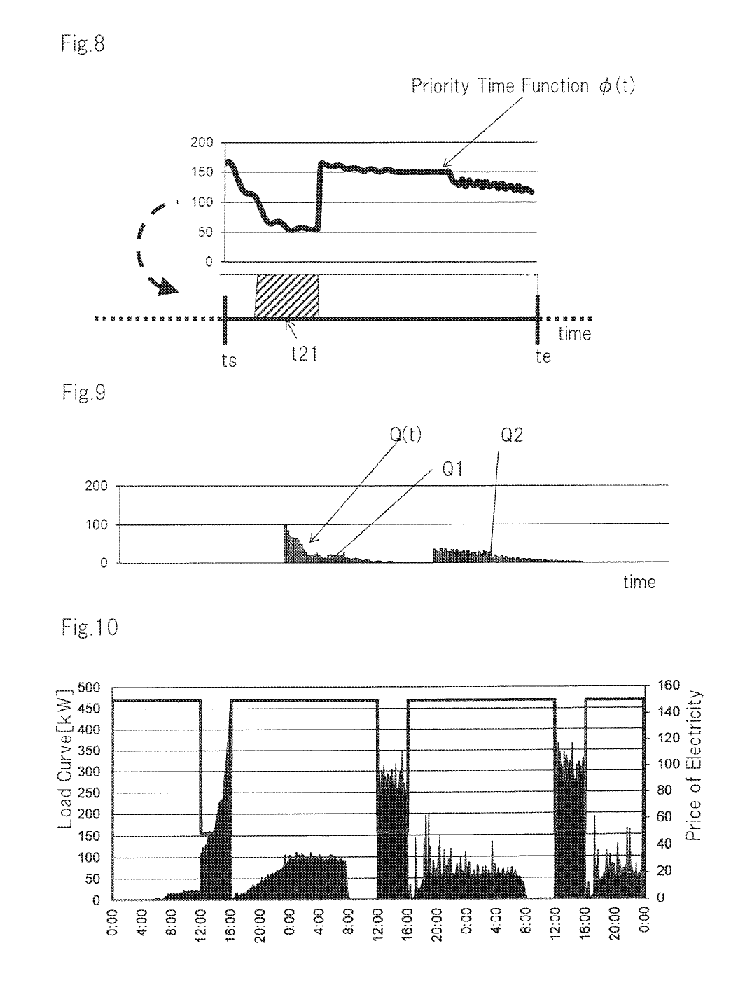

FIG. 8 is a diagram showing one example of time t, priority time function φ(t) and supplying time period t21.

In FIG. 8, time ts indicates the connection start time, time te indicates the scheduled connection end time. Time period ts−te indicates the connection time period, the period before time ts and the period after time te indicate non-connection time periods. Priority time function φ(t) is defined in connection time period ts−te.

Schedule calculator 105b determines a supplying time period so that, for example, the recommended degree of power to be supplied at each point of time in the supplying time period becomes equal to or higher than the recommended degree of power to be supplied at each point of time in other than the supplying time period.

For example, schedule calculator 105b sequentially selects points of time in the order of lower value of priority time function φ(t), from connection time period ts−te where priority time function φ(t) is defined.

Then schedule calculator 105b selects a time period that includes the selected points of time and does not include unselected points of time as a candidate supplying time period, and ends selection of points of time if the candidate supplying time period reaches the required charging time, and determines the candidate supplying time period as the supplying time period.

The supplying time period may be a single continuous period of time, or may be formed of separate multiple periods of time.

Here, if priority time function φ(t) takes the same value at multiple points of time, schedule calculator 105b selects the closet point of time to the point of time already selected. If priority time function φ(t) takes the same value at multiple points of time with no point of time selected, schedule calculator 105b selects one of the multiple points of time, at random.

When determining supplying time periods or determining a charging schedule, schedule calculator 105b transmits the determined charging schedule from information acquisition unit 102 to signal transmitter 4 (Step S611). The determined charging schedule transmitted at this time indicates the supplying time period, the output power value to be supplied at each point of time in the supplying time period.

Here, signal transmitter 4, when receiving the determined charging schedule, updates determined power amount signal Q(t) based on the determined charging schedule and transmits the updated determined power amount signal Q(t) to each charging control system 101.

FIG. 9 is a diagram showing one example of determined power amount signal Q(t) after updating.

In FIG. 9, part indicated by Q1 and part indicated by Q2 are newly added.

Schedule calculator 105b, when transmitting the determined charging schedule from information acquisition unit 102 to signal transmitter 4, notifies the determined charging schedule to charging control unit 106.

Charging control unit 106, when receiving the determined charging schedule, controls charging of storage battery 111 in accordance with the determined charging schedule (Step S612).

Here, at Step S612 charging control unit 106 supplies electric power at the output power value, from power grid 7 to storage battery 111 in the supplying time period designated by the determined charging schedule.

On the other hand, when, at Step S605, priority time function calculator 105a cannot acquire the scheduled connection end time and the required charging amount within a predetermined period of time after notification of the acquisition request, priority time function calculator 105a provides notice of a charging command to instruct charging control unit 106 to start charging.

When, at Step S608, the expected connection time is less than the required charging time, priority time function calculator 105a provides notice of a charging command to charging control unit 106.

Charging control unit 106, when receiving a charging command, supplies electric power at the output power value from power grid 7 to storage battery 111.

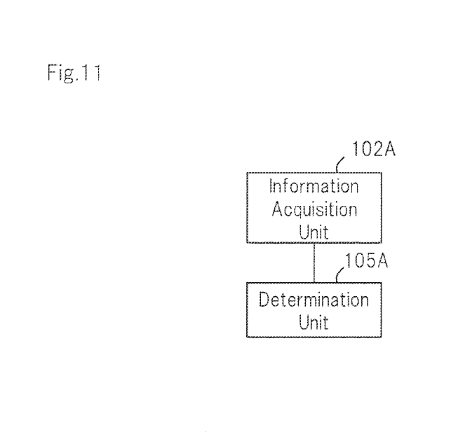

FIG. 10 is a diagram showing a simulation result when the above method is applied. Here, following FIG. 1, FIG. 10 shows a simulation result of change of load in three consecutive days, a holiday, a week day and subsequent week day, in charging control system having 1,000 EVs connected. Herein, it is assumed similarly to FIG. 1 that the price of electricity is 150 yen/kwh as the basic price and 50 yen/kwh from 10:00 to 12:00 and that the price of electricity is indicated at 0:00 every day.

In FIG. 10, the solid line shows the price of electricity while the curve filled with black shows the load curve for 1,000 EVs.

In FIG. 1, EVs start charging all at once at 10:00 when the price of electricity is lowered, forming sharp peaks of 2,500 kW.

On the other hand, in FIG. 10 corresponding to the present exemplary embodiment, it is understood that the charging time period shifts to 10:00 through 12:00 when the price of electricity is low and when the demand curve exhibits 200 to 300 kW at maximum, sharply reducing peak electricity use in the load curve.

Next, the effect of the present exemplary embodiment will be described.

According to the present exemplary embodiment, information acquisition unit 102 receives determined power amount signal Q(t). Determination unit 105 determines a supplying time period based on determined power amount signal Q(t).

In determined power amount signal Q(t), the duration in which Q(t) is not zero means a supplied time period during which electricity is supplied to power-supplied targets other than storage battery 111. Therefore, determination unit 105 can recognize supplied time periods, by reference to determined power amount signal Q(t) and can determine time periods that do not include the supplied time periods as supplying time periods. Accordingly, even though all power-supplied targets are not controlled by an apparatus or system that manages individual charging schedules of multiple power-supplied targets, it is possible to prevent timing congestion for supplying electric power to a plurality of power-supplied targets.

The above effect can also be obtained in a charging control system formed of information acquisition unit 102A that receives determined power amount signal Q(t) and determination unit 105A that determines supplying time periods based on determined power amount signal Q(t).

FIG. 11 is a diagram showing a charging control system formed of information acquisition unit 102A and determination unit 105A.

In this exemplary embodiment, determined power amount signal Q(t) indicates the amount of supplied power to other power-supplied targets at each point of time in supplied time periods. Accordingly, determination unit 105 can determine a time period in which the amount of supplied power is relative low, as the supplying time period, by referring to determined power amount signal Q(t). As a result, it is possible to prevent timing congestion for supplying electric power to the plurality of power-supplied targets from power grid 7.

Further, in this exemplary embodiment, information acquisition unit 102 receives price signal P(t) in addition to determined power amount signal Q(t). Determination unit 105 determines a supplying time period based on determined power amount signal Q(t) and price signal P(t). Accordingly, it is possible to prevent timing congestion for supplying electric power to the plurality of power-supplied targets from power grid 7, by taking into account the price of electricity.

Further, in this exemplary embodiment, determination unit 105 determines a supplying time period based on the determined electric power and the price of electricity at each point of time in the connection time period from the start time of connecting to charging control system 101 for storage battery 111 to the scheduled connection end time. Accordingly, it is possible to prevent timing congestion for supplying electric power to the plurality of power-supplied targets from power grid 7 in the connection time period, by taking into account the price of electricity.

Further, in this exemplary embodiment, determination unit 105 generates priority time function φ(t) indicates the recommended degree of power to be supplied at each point of time, based on the determined electric power and the price of electricity at each point of time in the connection time period. Determination unit 105 determines a supplying time period based on the recommended degree of power to be supplied given by priority time function φ(t).

Priority time function φ(t) that indicates the recommended degree of power to be supplied depends on the determined electric power and the price of electricity. Accordingly, when determining a time period for supplying electric power by taking into account the determined electric power and the price of electricity, it is possible to determine the time period for supplying electric power based on one index, i.e., the recommended degree of power to be supplied, and thus it is possible to simplify the method for determining the time period for supplying power.

Further, in the present exemplary embodiment, determination unit 105 assigns weights to determined power amount signal Q(t) and price signal P(t) in accordance with coefficients w1 and w2 to generate priority time function φ(t) based on the weighted result. Accordingly, determined power amount signal Q(t) and price signal P(t) can be weighted, so that it is possible to determine a time period for supplying electric power by giving priority to determined power amount signal Q(t), or determine a time period for supplying electric power by giving priority to price signal P(t).

Moreover, in the present exemplary embodiment, determination unit 105 lowers the recommended degree of power to be supplied as the determined electric power after weighting is greater, and lowers the recommended degree of power to be supplied as the determined electric price after weighting is higher. Accordingly, the recommended degree of power to be supplied can be increased at a point of time when the determined electric power is lower and the determined price of electricity after weighting is higher, hence it is possible to select a time period including points of time when the determined electric power is low and the price of electricity after weighting is low, as the time period for supplying electric power.

In the present exemplary embodiment, charging control unit 106 supplies electric power to storage battery 111 in a time period for supplying electric power. Accordingly, it is possible to prevent timing congestion for supplying electric power to the plurality of power-supplied targets.

In the present exemplary embodiment, charging control unit 106 supplies electric power to storage battery 111 from power grid 7 that supplies electric power to storage batteries (other storage batteries) that are different from storage battery 111. Accordingly, it is possible to prevent the supply of power from power grid 7 from becoming unstable.

In the present exemplary embodiment, determination unit 105 selects a time period for supplying electric power so that the recommended degree of power to be supplied at each point of time in the time period for supplying electric power is equal to or higher than the recommended degree of power to be supplied at each point of time in other than the time period for supplying electric power. Accordingly, it is possible to select a time period in which the recommended degree of power to be supplied is relatively high, as a time period for supplying electric power.

In the present exemplary embodiment, determination unit 105 determines a time period for supplying power based on the required charging amount. Accordingly, it is possible to determine a time period for supplying power, by taking into account the required charging amount.

In the present exemplary embodiment, as power-supplied targets, storage batteries such as onboard storage batteries and the like are used. Therefore, for example, it is possible to prevent timing congestion for supplying electric power to high-capacity stationary storage batteries and/or high-capacity storage batteries in EVs.

When a stationary storage battery is used as a power-supplied target, the connection time period is scheduled, for example, in a period of time during which the stationary storage battery is not used to supply electric power to other devices.

As power-supplied targets, power loads (loads) such as household electrical appliances may also be used. It should be noted that it is preferable that household electrical appliances that cannot provide desired functions if the supply of power is interrupted (e.g., rice cockers) be used as the power-supplied targets. In this case, the charging control system may be configured to permit the user, to select household electrical appliances to be managed, or to register a desired charging pattern and prepare a charging schedule so as to comply with the pattern.

Further, in the present exemplary embodiment, since the information to be given to the superior system from charging control system 101 is a charging schedule only, it is not necessary to give notice of information relating to daily life such as EV's stopping, starting and other important information.

Though, in the present exemplary embodiment, signal transmitter 4 is configured to send both determined power amount signal Q(t) and price signal P(t), the device for sending determined power amount signal Q(t) and the device for sending price signal P(t) may be provided separately.

Further, connection end time acquisition unit 104a2 is configured to receive scheduled connection end time from the user every time EV 110 is connected to charging control system 101. However, if EV 110 starts to be used at the same time every day, connection end time acquisition unit 104a2 may be set up with the start time for use of EV 110 and retain the use start time thus set as the scheduled connection end time.

When connection detection unit 104a1 also has the function of detecting the end of connection between EV 110 and charging control system 101, priority time function calculator 105a may be configured to store in storage unit 103 the log of time at which connection between EV 110 and charging control system 101 is ended at each day of the week, and thereby estimate the scheduled connection end time every day of week, using the history.

Though priority time function calculator 105a determines priority time function φ(t), using the formula: φ(t)=w1·Q(t)+w2·P(t), priority time function φ(t) should not be limited to φ(t)=w1·Q(t)+w2·P(t) but can be changed as appropriate. For example, use of φ(t)=w1·Q(t)×w2·P(t) may be used.

Further, charging control system 101 may be realized by a computer. In this case, the computer loads and runs a program stored in a recording medium such as a computer-readable CD-ROM (Compact Disk Read Only Memory) to thereby execute the functions of the charging control system. The recording medium is not limited to CD-ROMs but can be changed as appropriate.

Alternatively, the program may be delivered to a computer via communication lines, so that the computer that receives the delivery can run the program. Further, the program may be one that realizes only part of the above-described functions. Moreover, the program may be a so-called differential file (differential program), which realizes the above-described functions in combination with the program that is already recorded on the computer.

In the exemplary embodiments described heretofore, the illustrated configurations are mere examples, and the present invention should not be limited to the above configurations.

Although the present invention has been explained with reference to the exemplary embodiments, the present invention should not be limited to the above exemplary embodiments. Various modifications that can be understood by those skilled in the art may be made to the structures and details of the present invention within the scope of the present invention. This application claims priority based on Japanese Patent Application No. 2013-150784, filed on Jul. 19, 2013, the disclosure of which is incorporated herein in its entirety by reference.

### REFERENCE SIGNS LIST

1a to 1d HEMS devices
2a BEMS device
3a to 3c charging stations 3a to 3c
4 signal transmitter
5 power distribution line network
6 transformer substation
7 power grid
8a-8j EV
9a-9c stationary energy storage
10 management system
101 charging control system
102, 102A information acquisition unit
103 storage unit
104 EV data acquisition unit
104a connection time information acquisition unit
104a1 connection detection unit
104a2 connection end time acquisition unit
104b required charging amount acquisition unit
105, 105A determination unit
105a priority time function calculator
105b schedule calculator
106 charging control unit
110 EV
111 storage battery
201 charging control apparatus
202 communication control unit
203A main storage unit
203A-1, 203B-1 main control interface unit
204 input unit
204-1 I/O interface unit
205 operation unit
206 switch control unit

1. A power control system for controlling supply of electric power to a load or storage battery, comprising:
a receiving means for acquiring power supply information including the amount of electric power to be supplied to other loads or storage batteries and a time period to supply electric power; and,
a determining means for determining a time period to supply electric power to the load or storage battery based on the power supply information.

2. The power control system according to claim 1, wherein the power supply information also includes information for specifying a supplied amount of electric power to be supplied to the other loads or storage batteries at each point of time in the time period in which electric power is supplied to the other loads or storage batteries.

3. The power control system according to claim 2, wherein the receiving means further acquires price information for specifying the price of electricity at each point of time, and,
the determining means determines a time period to supply electric power to the load or storage battery, also with reference to the price information.

4. The power control system according to claim 3, further comprising a target information receiving means for acquiring target information for specifying a permissible time period during which supply of electric power to the load or storage battery is permitted, wherein
the determining means determines a time period to supply electric power to the load or storage battery, based on the supplied amount of electric power at each point of time in the permissible time period and the price information.

5. The power control system according to claim 4, wherein the determining means, based on the supplied amount of electric power at each point of time in the permissible time period and the price information, generates the recommended degree of power to be supplied, which represents the recommended degree of power to be supplied to the load or storage battery at each point of time, and based on the recommended degree of power to be supplied, determines a time period to supply electric power to the load or storage battery.

6. The power control system according to claim 5, further comprising a storing means for storing weighting information for specifying weights for the supplied amount of electric power and the price of electricity, wherein
the determining means, based on the weighting information, assigns weights to the supplied mount of electric power and the price of electricity at each point of time in the permissible time period, and generates the recommended degree of power to be supplied at each point of time, based on the executed result of the weighting.

7. The power control system according to claim 6, wherein the determining means lowers the recommended degree of power to be supplied as the supplied amount of electric power after execution of the weighting increases, and lowers the recommended degree of power to be supplied as the price of electricity after execution of the weighting becomes higher.

8. The power control system according to claim 1, further comprising a supplying means for supplying electric power to the load or the storage battery, in a time period for supplying electric power to the load or storage battery.

9. The power control system according to claim 8, wherein the supplying means supplies electric power to the load or storage battery from a power grid for supplying electric power to the other loads or storage batteries.

10. The power control system according to claim 5, wherein the determining means determines a time period to supply electric power to the load or storage battery so that the recommended degree of power to be supplied at each point of time in the time period during which electric power is supplied to the load or storage battery will be equal to or greater than the degree of recommendation for supplying power at each point of time in the time period other the time period during which electric power is supplied to the load or storage battery.

11. The power control system according to claim 1, further comprising a specifying means for specifying the amount of supplied electric power supplied to the load or storage battery, based on predetermined information, wherein
the determining means determines a time period to supply electric power to the load or storage battery, also based on the amount of supplied electric power.

12. The power control system according to claim 1, wherein the storage battery is a storage battery installed in a moving object.

13. A power control method in which a power control system controls supply of electric power to a load or storage battery, comprising the steps of:
acquiring power supply information including the amount of electric power to be supplied to other loads or storage batteries and a time period to supply electric power; and,
determining a time period to supply electric power to the load or storage battery based on the power supply information.

14. A computer-readable recording medium recorded with a program that causes a computer to execute control of supplying electric power to a load or storage battery, wherein
the program causes the computer to perform,
a receiving step of acquiring power supply information including the amount of electric power to be supplied to other loads or storage batteries and a time period to supply electric power; and,
a determining step of determining a time period to supply electric power to the load or storage battery based on the power supply information.
